(19) United States
(12) Patent Application Publication
(10) Pub. No.: US 2025/0131007 A1
(43) Pub. Date: Apr. 24, 2025

(54) GENERATION OF HIERARCHICAL PRODUCT PARAMETERS

(71) Applicant: DevRev, Inc., Palo Alto, CA (US)

(72) Inventor: Shlomi Vaknin, San Jose, CA (US)

(73) Assignee: DevRev, Inc., Palo Alto, CA (US)

(21) Appl. No.: 18/919,209

(22) Filed: Oct. 17, 2024

Related U.S. Application Data
(60) Provisional application No. 63/544,716, filed on Oct. 18, 2023.

(51) Int. Cl. G06F 16/25

(52) U.S. Cl. CPC G06F 16/254

(57) ABSTRACT

The present subject matter discloses techniques for automatically generating and updating hierarchical product parameters in a hierarchy of operational factors for offerings deployed in a connected environment. The system extracts data from multiple connected data sources, generates product parameter seeds by converting the extracted data into a standard format, groups the product parameter seeds into partition sets based on similarities, merges product parameter seeds in each partition set to form a merged product parameter seed, and transforms the merged product parameter seed into a hierarchical product parameter. The hierarchical product parameter is then updated in a hierarchical product parameter map. The system handles data from diverse sources with different formats by converting inputs into a common product parameter seed format for consistent processing.

### CROSS-REFERENCE TO RELATED APPLICATIONS

The present application claims the benefit of priority to U.S. Provisional Application 63/544,716, filed on Oct. 18, 2023, which is hereby incorporated by reference in its entirety.

### TECHNICAL FIELD

The subject matter described herein, in general, relates to generating a hierarchical product parameter, and in particular to, transforming product parameter seeds into the hierarchical product parameter for an offering operating in a unified platform.

### BACKGROUND

Typically, offerings, such as products and services deployed in a computing environment touch upon, inhabit, or interrelate with numerous disparate locations, devices, and/or entities that pertain to the offerings. Each of these disparate locations, devices, and/or entities may inhabit a compartmentalized ecosystem that is distinct from—and effectively walled off from—any of the other compartmentalized ecosystems operating in the computing environment. Certain organizations may develop and deploy products and/or services in a connected computing environment. The connected computing environment in relation to a particular product and/or service of the organization includes one or more distinct ecosystems inhabited by user-end entities and developer-end entities of the particular product and/or service of the organization. Each of the one or more distinct ecosystems, while operating, produces a stream of data pertaining to events that describe an activity or change in the ecosystems. The events may generally be unique to each distinct ecosystem but may reference some entities that span the distinct ecosystems. The product and/or service and one or more entities associated with the product and/or service are common across all ecosystems and the events reference the common components of the product and/or service either directly or indirectly.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are not therefore to be considered limiting of its scope, the present subject matter will be described and explained with additional specificity and detail through the use of the accompanying drawings.

FIG. 1A illustrates an existing system of the system or event hierarchy.

FIG. 1B illustrates a block diagram of a connected environment, in accordance with an example implementation of the present subject matter;

FIG. 2 illustrates a system for automatically generating and updating hierarchical product parameters of an offering in a hierarchy of operational factors associated with the offering, according to an example implementation of the present subject matter;

FIG. 3A illustrates a block diagram of a clue-generating module of the part discovery module suitable for implementing an embodiment of the present subject matter;

FIG. 3B illustrates a conceptual schematic for generation of product parameter seeds, according to an example implementation of the present subject matter;

FIG. 4 illustrates a process of extraction and conversion of product parameter seeds, according to an example implementation of the present subject matter;

FIG. 5 illustrates a partitioner unit for grouping of generated product parameter seeds, according to an example implementation of the present subject matter;

FIG. 6 illustrates a method for grouping the product parameter seeds into partition sets, according to an example implementation of the present subject matter;

FIG. 7 illustrates a merger module for merging the product parameter seeds in the partition set, according to an example implementation of the present subject matter;

FIG. 8 illustrates a method for merging each partition set, according to an example implementation of the present subject matter;

FIG. 9 illustrates a transform-storage module for transforming the merged product parameter seed into a hierarchical product parameter in a hierarchy of operational factors associated with the offering, according to an example implementation of the present subject matter;

FIG. 10 illustrates a method for transforming the merged product parameter seed into the hierarchical product parameter in the hierarchy of operational factors associated with the offering, according to an example implementation of the present subject matter;

FIG. 11 illustrates a method for processing a product parameter seed into a hierarchical product parameter in a hierarchy of operational factors associated with the offering, according to an example implementation of the present subject matter;

FIG. 12 is a block diagram of an illustrative computing system suitable for implementing an embodiment of the present invention.

### DETAILED DESCRIPTION

In the connected computing environment, events related to offerings, such as products or services are often organized into hierarchical structures. The hierarchical structure typically includes a hierarchy of operational factors centered around a product or service, which serves as the primary entity to which all hierarchical product parameters are related and branched. In an example, an operational factor may refer to a component or piece of the hierarchy of operational factors associated with the offering deployed in the connected environment. Exemplary operational factors include a capability, a feature, a microservice, and the like. The hierarchical product parameter may refer to an operational factor in the hierarchy of operational factors. Within the hierarchy of operational factors, tickets, issues, or work items are commonly associated with specific hierarchical product parameters of the offering. The hierarchical product parameter is referred to as a part of the offering, such as a part of a product or a part of a service. Further, the hierarchy of operational factors is referred to as a part hierarchy centered around the offering, such as a product hierarchy and a service hierarchy.

Conventional approaches taken by software or service organizations face immense struggles to effectively create and manage the hierarchy of operational factors. For example, one conventional approach is to use a manual process to analyze data streams pertaining to activities occurring at the distinct ecosystems, analyze the activities in order to identify events associated with products or services, create hierarchies of operational factors pertaining to products or services based on the identified events, and manage the hierarchies. The conventional manual approach, however, presents several challenges. Manual creation of hierarchies of operational factors by organizing and updating large volumes of data streams may require a significantly high level of human effort and may be time-consuming and prone to human error. Moreover, as products and services evolve rapidly in response to market demands and technological advancements, manually created hierarchies may struggle to keep pace with the latest deployments and updates, which may result in creating an outdated or inaccurate representations of the product or service in the hierarchy of operational factors. In an example, any inaccuracy in the representations of the product or service may lead to inefficiencies in issue tracking, resource allocation, and overall product management.

Further, any discrepancy between an actual state of the offering and its representation in the hierarchy of operational factors may have adverse consequences. For instance, any discrepancies in the hierarchy of operational factors may lead to misallocation of resources, delays in issue resolution, and difficulties in tracking the progress of feature implementations or bug fixes. Furthermore, the discrepancies in the hierarchy may hinder effective communication between different teams within an organization, such as development, quality assurance, and customer support.

In certain scenarios, with large volumes of data from various sources, each data with its own format and structure, it may be difficult to identify, integrate, and process the relevant data associated with a specific event. The difficulty may lead to creating an inaccurate representation of the product or service in the hierarchy of operational factors. In an example, a large volume of data associated with the same event may be collected from different sources, thereby creating inconsistencies or duplications in data leading to an inaccurate and unreliable representation of the product or service in the hierarchy of operational factors. There is a need for automated generation of new hierarchical product parameters, i.e., the parts and modification of existing parts of product or service hierarchy by collecting data from disparate sources used in the enterprise so the hierarchies continuously reflect the reality as being perceived by the events.

The present subject matter discloses techniques to automatically generate hierarchical product parameters of an offering. In an example, the offering may be a product or a service. According to one exemplary embodiment, the present subject matter provides systems and methods for automatically generating and updating hierarchical product parameters of the offering in a hierarchy of operational factors associated with the offering. The hierarchical product parameter may be understood as a parameter associated with a specific level of granularity in the hierarchy of operational factors associated with the offering. The operational factors associated with the offering may span over the plurality of distinct ecosystems operating in relation to the product deployed in the connected environment. For instance, the operational factors may be divided amongst user-end entities and/or developer-end entities responsible for generating them or fixing them.

The hierarchy of operational factors associated with the offering, such as the product or service includes the product or service as the origin entity. The product or service may have one or more capabilities, which are the core unit a user-end entity interacts with and to which revenue can be assigned. Capabilities may have an associated API namespace if delivered as a software product or service. Each capability may comprise an independent set of features, where features define product offerings that can be measurable, observable, upgradable, and potentially monetizable. In an example, the capabilities and/or features may link to backend constructs, termed microservices, most commonly, if the product/service is a software product or service. A microservice may be referred to as a unit of deployment and may be an operational factor which composes a feature or capability.

The term “operational factor” thus refers to a component or piece of the hierarchy of operational factors associated with the product and/or service deployed in the connected environment. Exemplary operational factors include a particular capability, feature, microservice, sub-module, and the like. The term “hierarchical product parameter” refers to an operational factor in the hierarchy of operational factors for a particular ecosystem of the connected environment. In an example, for each specific ecosystem, there may be a hierarchy of the operational factors associated with the product and/or service and one or more hierarchical product parameters in relation to the operational factors. As stated above, the hierarchical product parameter is the part of the product or service and the hierarchy of operational factors is the part hierarchy centered around the product or service.

In an example implementation, the system automatically generates and updates hierarchical product parameters of the product or service in a hierarchy of operational factors based on the generation of product parameter seeds. Product parameter seeds may be intermediary memory structures that may be stored, inspected, and retrospected. The product parameter seeds are referred to as clues. Further, the product parameter seeds may be transformed into one or more hierarchical product parameters in the hierarchy of operational factors associated with the product and/or service. The terms offering, product, and service have been used interchangeably throughout the specification. The product parameter seeds may be generated by extracting data from a plurality of connected data sources used in an organization and by converting the extracted data into a standard product parameter seed format. In an example, large volumes of data streams may be extracted from the various connected data sources, which are then analyzed and processed by converting each data into a standard format representing the data structure of the hierarchical product parameters in the hierarchy of operational factors. The standard product parameter seed format may be referred to as a uniform format for the one or more product parameter seeds of a product parameter seed type.

The generated product parameter seeds may be grouped into multiple partition sets, where each partition set comprises product parameter seeds that refer to a similar object (e.g., features, microservices, sub-modules) of the product or service. In an example, the grouping of the product parameter seeds may be performed based on similar aspects of attributes, properties of data fields, and hash numbers attributed to data fields that refer to similar objects. Further, the similarity may be syntactic or semantic. In another example, Artificial Intelligence (AI) and Machine Learning (ML) techniques may be employed to derive contextual or semantic similarities between product parameter seeds. Additionally, each partition set may comprise a group of product parameter seeds with similar data field types. For each partition set, the product parameter seeds may then be merged to form a merged product parameter seed. In an example, the system may determine which product parameter seed has a better source for a specific field or set of fields, and the merged product parameter seed may be structured in an identical format to the product parameter seeds contained in the partition set. Each merged product parameter seed may be transformed into a hierarchical product parameter. The created hierarchical product parameter may then be updated and stored in a table of the system. In an example, the transformed hierarchical product parameter may be converted into a format compatible with a schema defined in the available databases.

The present subject matter thus provides a flexible and efficient approach to manage data from various data sources, process the data, and update the hierarchy of operational factors while maintaining data integrity and relationships. The system handles data from diverse data sources with different formats by converting all inputs into a common product parameter seed format for consistent processing. By extracting data from multiple data sources and converting it into product parameter seeds, the system automates a significant portion of the data integration process, thereby reducing manual effort and potential errors. Further, the modular design of the system allows for easy addition of new data sources and product parameter seeds, making it adaptable to growing organizational needs.

Furthermore, by organizing information into a structured hierarchy of operational factors, the system makes it easier for organizations to analyze, query, and derive insights from their data. The system can process new data and update existing hierarchical product parameters in the hierarchy, ensuring that the organization's data remains current and accurate. The common product parameter seed format and standardized hierarchical product parameter structure also facilitates better integration with other systems and tools within the organization. These technical advantages collectively contribute to a more efficient, reliable, accurate, and manageable system for automatically generating new hierarchical product parameters of the offering, addressing key challenges faced in conventional systems.

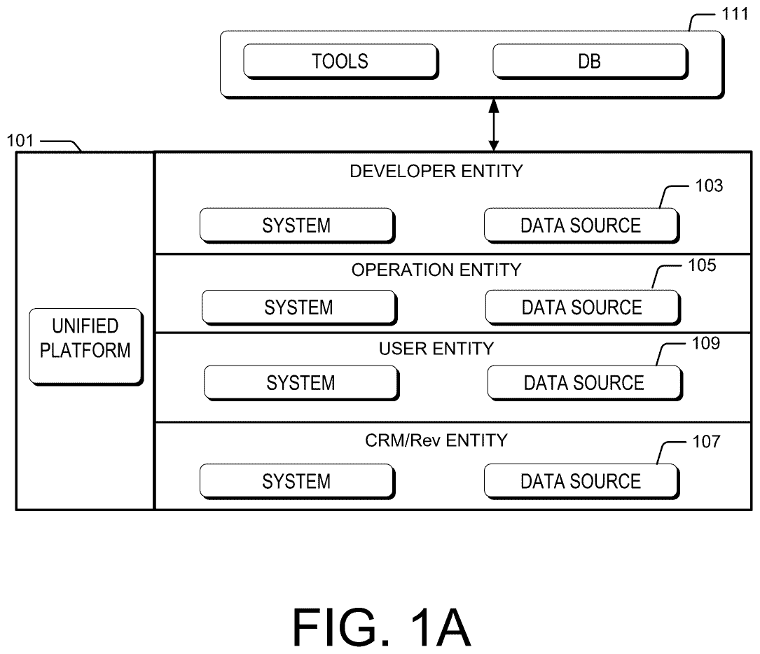

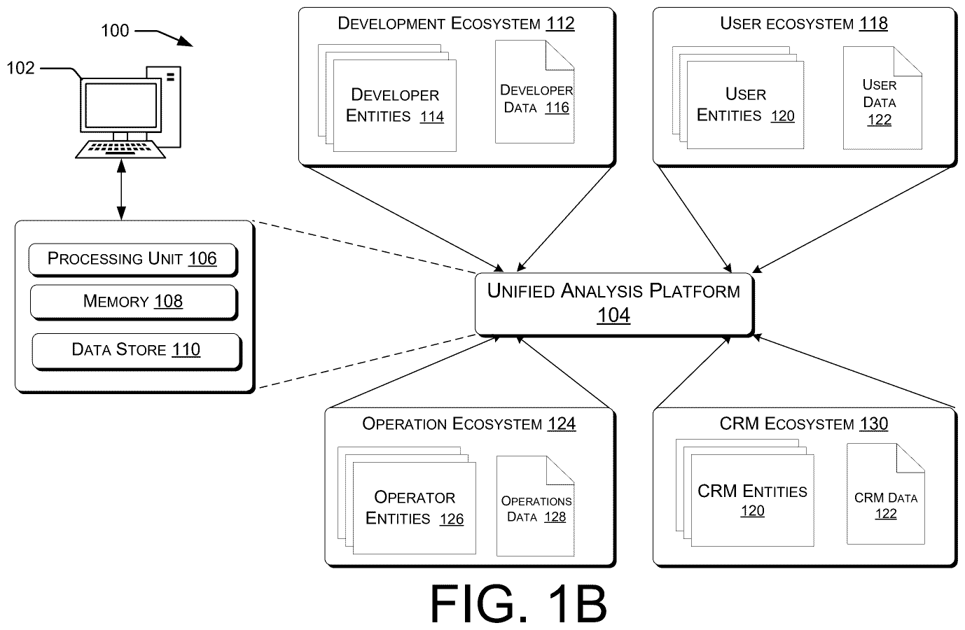

The present subject matter is further described with reference to FIGS. 1-12. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1A illustrates an existing system of the system or event hierarchy. FIG. 1B illustrates a block diagram of a connected environment, in accordance with an example implementation of the present subject matter. For the sake of brevity, FIG. 1A has been explained in conjunction with FIG. 1B.

FIG. 1A shows a system that provides a unified platform 101 to implement an automated template for automatically clustering events into event hierarchies and autonomous classification and communication between these hierarchies. Event hierarchies are classified as Development-related hierarchies and Revenue-related hierarchies. This figure illustrates event hierarchies about developer entities/systems 103 (that may correspond to developer data), user entities/systems 109 (that may correspond to user data), CRM/Revenue-based entities/systems 107 (that may correspond to CRM/Rev data), and admin/operator entities/systems 105 (that may correspond to Ops (“operations”) data). The unified platform 101 is a pluggable interface, wherein its implementation might be rule-based or through Artificial intelligence using machine learning-based techniques to automatically process the data and events from the multiple event hierarchies and to generate one or more databases 111 comprising both raw data and properly categorized data so that analysis tools 111 can be used to extract useful information and accurate results.

FIG. 1B provides an illustration of a connected environment 100, in accordance with an example implementation of the present subject matter. The connected environment 100 may include multiple entities operating in relation to an offering, such as a product. In an example, the multiple entities operating in the connected environment 100 may inhabit distinct ecosystems pertaining to the functionality being executed on each entity in the connected environment 100. The connected environment 100 may be controlled by a system (not shown). The system may include a user station 102 to operate a unified analysis platform 104. The unified analysis platform 104 corresponds to the unified platform 101. The user station 102 that hosts the unified analysis platform 104 includes any type of computing device that may be used to implement, operate, or interface with the unified analysis platform 104. The computing device may include, for example, workstations, personal computers, mobile devices, servers, hosts, nodes, or remote computing terminals. The user station 102 comprises a display device, such as a display monitor, for displaying an interface to users at the user station. The user station 102 also includes one or more input devices (not shown) for a user to achieve operational control over the activities of the connected environment 100. The input devices may include a mouse and/or keyboard to manipulate a pointing object in a graphical user interface to generate user inputs.

The user station 102 may be communicably coupled to a processing unit 106, a memory 108, and a data store 110. The processing unit 106 enables the user station 102 to run at least one operating system and other applications and services. The processing unit 106, amongst other capabilities, may be configured to fetch and execute computer-readable instructions stored in the memory 108. The processing unit 106 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labeled as “processing unit”, may be provided through the use of dedicated hardware as well as hardware capable of executing machine-readable instructions.

The functions, performed by the processing unit 106, may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the user station 102 to interact with different components. Further, the interface may enable the user station 102 to communicate with entities, for example, the entities operating in the various distinct ecosystems, web servers, and external repositories. The interface may facilitate multiple communications within a wide variety of networks and protocol types, including wireless networks, wireless Local Area Network (WLAN), Radio Access Network (RAN), satellite-based network, and the like.

The memory 108 may be coupled to the processing unit 106 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The operation of the unified analysis platform 104 involves analysis of large amounts of data streams captured from the distinct ecosystems to identify events occurring at the distinct ecosystems for processing by the unified analysis platform 104. The unified analysis platform 104 implements autonomous clustering of the events to generate hierarchies of operational factors associated with the products as well as autonomous classification and communication between these hierarchies.

Any number or type of events generated by distinct ecosystems may be acted upon by embodiments of the invention. For example, the connected environment 100 includes a development ecosystem 112 having developer entities 114 and generating developer data 116, a user ecosystem 118 comprising user entities 120 and generating user data 122, an operation ecosystem 124 comprising operator entities 126 and generating operations data 128, a Customer Relationship Management (CRM) ecosystem 130 comprising CRM/Revenue-based entities 132, and generating CRM data 134. For the sake of understanding, the development ecosystem 112 and operation ecosystem 124 may be collectively referred to as developer-end ecosystems, and the user ecosystem 118 and CRM ecosystem 130 may be collectively referred to as user-end ecosystems.

In some embodiments, the unified analysis platform 104 uses machine-learning based techniques to automatically process the data and events generated by the distinct ecosystems to generate a hierarchy of operational factors associated with the product or service. The unified analysis platform 104 stores both raw data generated by each distinct ecosystem and the hierarchical product parameters map illustrating properly categorized data at the data store 110, so that the processing unit 106 can be used to accurately identify useful and accurate hierarchical product parameters. The present subject matter outlines an application of the inventive method for the Software-as-a-Service (SaaS) industry, but it is not limited to this industry.

Embodiments of the present subject matter operate by capturing data streams from the distinct ecosystems within the connected environment 100 through a series of triaging stages. In an example, objects associated with the captured data streams may be “funneled” through the series of triaging stages to generate the hierarchical product parameters map containing meaningful sets of analyzed data. The raw data generated by the distinct ecosystems are likely to correspond to an extremely large volume of data, which individually by themselves may not provide enough cross-hierarchy context to be meaningful. The large volume of raw data, when analyzed in a unified way across the distinct ecosystems, may be triaged into increasingly smaller and more meaningful sets of data that can be usefully provided to developers, users, managers, and/or any other party that can benefit from a unified cross-hierarchy look at events and data within the connected environment 100.

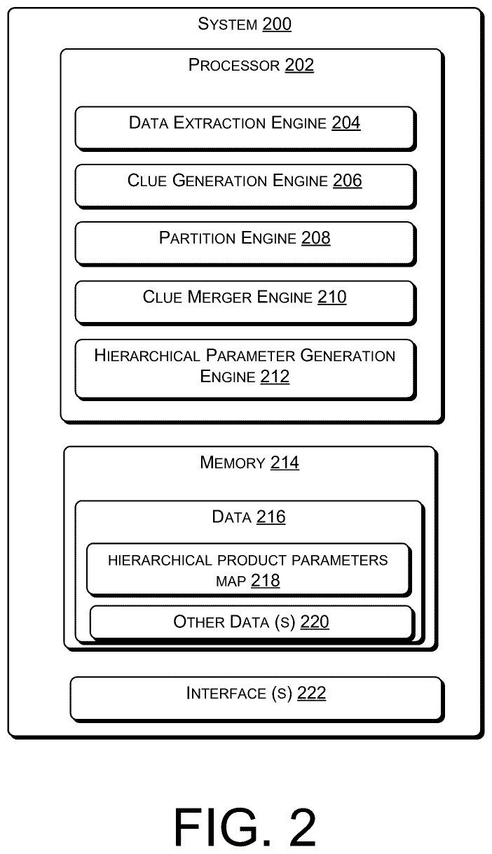

FIG. 2 illustrates a system 200 for automatically generating and updating hierarchical product parameters of an offering, such as a product or a service in a hierarchy of operational factors associated with the offering, according to an example implementation of the present subject matter. In an example, the system 200 may be implemented in the connected environment 100. In an example, the system 200 may automatically discover and update hierarchical product parameters for a cloud-based infrastructure offering a wide range of services. In some cases, the system 200 may automatically discover and update hierarchical product parameters to provide an up-to-date representation of the product hierarchy, including information on component performance, customer issues, and manufacturing status. The system 200 may include a processor 202, a memory 214, and an interface 222.

The processor 202 may correspond to the processing unit 106 and the memory 214 may correspond to the memory 108. The processor 202 may include one or more engines 204, 206, 208, 210, 212. The processor 202, amongst other capabilities, may be configured to fetch and execute computer-readable instructions stored in the memory 214.

The memory 214 may be coupled to the processor 202 and may, among other capabilities, provide data and instructions for generating different requests. The memory 214 may include data 216 corresponding to the hierarchical product parameters map associated with the product and/or service. The interface(s) 222 may include a variety of machine-readable instructions-based interfaces and hardware interfaces that allow the system 200 to interact with different entities in the connected environment. Further, the interface 222 may enable the components of the system 200 to communicate with computing devices, web servers, and external repositories. The interface may facilitate multiple communications within a wide variety of networks and protocol types, including wireless networks, wireless Local Area Network (WLAN), RAN, satellite-based network, and the like.

The engines 204, 206, 208, 210, 210 may include routines, programs, objects, components, data structures, and the like, which perform particular tasks or implement particular abstract data types. The engines 204, 206, 208, 210, 212 may further include modules that supplement applications on the system 200, for example, modules of an operating system. Further, the engines 204, 206, 208, 210, 212 may be implemented in hardware, instructions executed by a processor, or by a combination thereof.

In an implementation, the engines 204, 206, 208, 210, 212 may be machine-readable instructions which, when executed by the processor 202, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 204, 206, 208, 210, 212 may perform different functionalities. The engines 204, 206, 208, 210, 212 may include a data extraction engine 204, a product parameter seed generation engine 206, a partition engine 208, a product parameter seed merger engine 210, and a hierarchical parameter generation engine 212. The functions of the engines 204, 206, 208, 210, 212 are explained below.

The data extraction engine 204 may collect data from a plurality of connected data sources within the organization. Each connected data source from amongst the plurality of connected data sources may operate in connection with the unified analysis platform 104. The sources may include, but are not limited to, databases, log files, API endpoints, user interfaces, and other data repositories. In an example, the data extraction engine 204 may collect cloud-scale applications data, which may include data events from monitoring servers, databases, tools, and services through a SaaS-based data analytics platform (e.g., Datadog®), natural language text from web pages, and event data like tracking source-code changes (git data). In another example, the data extraction engine 204 may collect data from a container orchestration system, for example, Kubernetes®. In yet another example, the data extraction engine 204 may collect real-time event data from Git Actions (e.g., pull request opened) and may obtain associated issues through GitHub webhook.L Additionally, the data extraction engine 204 may collect the data from the existing hierarchical product parameters map.

The collected data may be processed by the product parameter seed generation engine 206. In an example, the collected data may include Git data, Datadog® service data, pods, ingress data, existing hierarchical product parameters map, and Git Events. The product parameter seed generation engine 206 may perform several functions to generate product parameter seeds from the extracted data. Product parameter seeds may be referred to as meaningful data extracts (isomorphic variations of hierarchical product parameters) to automate the generation of hierarchical product parameters. For instance, the product parameter seed generation engine 206 may analyze the collected data extracts to identify relevant information that could indicate the existence or characteristics of a hierarchical product parameter of a product. In an example, the product parameter seed generation engine 206 may convert the analyzed data into a uniform format, creating what are referred to as “product parameter seeds”. The product parameter seeds may be structured in a standard format representing the data structure of the hierarchical product parameter in the hierarchy of operational factors associated with the offering. This standardization of data may facilitate easier integration, processing, and comparison of information from different data sources.

Further, each generated product parameter seed may refer to a shared object. The shared object may represent a potential hierarchical product parameter related to a product or service in the hierarchy of operational factors associated with the product or service. In an example, the product parameter seeds, in the standard format, may collectively represent various aspects or characteristics of the potential hierarchical product parameter. The representation of the product parameter seeds may include information such as the hierarchical product parameter's name, attributes, relationships to other parameters, or other relevant metadata. The system 200 may thus be designed to handle various types of data and convert them into meaningful product parameter seeds, allowing for adaptability to different organization's structures and data sources. The present technique may allow for automated discovery and representation of hierarchical product parameters within the product or service hierarchy, thereby reducing manual effort and improving accuracy in maintaining the hierarchy structure.

In an example implementation, the partition engine 208 may group the generated product parameter seeds into multiple partition sets. Each partition set may comprise a set or group of product parameter seeds that refers to a similar object (such as features, microservices, sub-modules, or other relevant entities). Within each partition set, the product parameter seeds may support and reinforce each other. The mutual support of the product parameter seeds may enhance the overall reliability and coherence of the partition sets, thereby leading to generating accurate hierarchical product parameters in the system.

In an example, the grouping of product parameter seeds into multiple partition sets may be performed based on various similarity criteria, which may include, but are not limited to similar aspects of attributes, such as prefixes and suffixes, properties of data fields, hash numbers attributed to data fields that refer to the similar objects, similar API endpoints, etc. The similarity may be syntactic or semantic. Further, the grouping of product parameter seeds into multiple partition sets may utilize various techniques to determine similarities between product parameter seeds. In an example, a prefix/suffix analysis may be performed to compare the beginning and end portions of attribute names or values. In another example, Artificial Intelligence (AI) and Machine Learning (ML) techniques may be employed to derive contextual or semantic similarities between product parameter seeds. In yet another example, rule-based techniques may be employed by applying predefined rules to categorize product parameter seeds based on a specific criteria.

The system 200 may support multiple types of product parameter seeds, such as revenue-related product parameter seeds and development-related product parameter seeds. Additionally, the system 200 may be flexible enough to accommodate a third type of product parameter seeds or more. In an example implementation, the grouping of product parameter seeds into multiple partition sets may be performed based on the type of product parameter seeds. For instance, for development-related product parameter seeds, grouping of product parameter seeds may be performed based on similarities in attributes, properties, or data fields. Further, for revenue-related product parameter seeds, grouping may be performed based on name similarities and similar API endpoints.

In an example implementation, the product parameter seed merger engine 210 may merge the product parameter seeds in each partition set to form a merged product parameter seed. The merged product parameter seed may represent the specific object and may maintain the standard product parameter seed format of the product parameter seeds in the partition set. In an example, each partition set may comprise a group of product parameter seeds with similar data field types. The group of product parameter seeds may be merged by the product parameter seed merger engine 210 to form the merged product parameter seed. The product parameter seed merger engine 210 may also analyze the product parameter seeds within the partition set to determine which product parameter seed provides the most reliable or comprehensive source for a specific field or set of fields. This determination of the reliable product parameter seed may be based on various factors, such as data completeness, recency, or source reliability. The merged product parameter seed may be structured in a format that is consistent with the individual product parameter seeds contained in the partition.

The product parameter seed merger engine 210 may employ a hierarchical approach to merge the product parameter seeds in the partition set. For instance, the product parameter seed merger engine 210 may first identify the most comprehensive product parameter seed within the partition set and use this as a base. The product parameter seed merger engine 210 may then supplement or update the base with information from other product parameter seeds in the set, prioritizing data from more reliable or recently used sources. In an example, the product parameter seed merger engine 210 may also implement conflict resolution techniques in scenarios when different product parameter seeds provide conflicting information for the same field. The conflict resolution techniques may include using predefined rules, statistical analysis, machine learning, or artificial intelligence techniques to decide which product parameter seeds to include in the merged product parameter seed. In some cases, the product parameter seed merger engine 210 may maintain metadata about the merging process, including the source of each piece of information in the merged product parameter seed. The information may allow for traceability and may facilitate future updates or corrections.

The merged product parameter seed may serve as a comprehensive representation of the information contained in the partition set, thereby providing a more accurate and complete picture of the object or entity being described than any individual product parameter seed. This merged product parameter seed may then be used in subsequent processes, such as hierarchical product parameter creation or an update in the hierarchical product parameter map.

In an example implementation, the hierarchical parameter generation engine 212 may transform the merged product parameter seed into the hierarchical product parameter in the hierarchy of operational factors for the offering operating in the unified platform. The hierarchical product parameter may be categorized as a revenue-related parameter, a development-related parameter, or another type of parameter, depending on the nature of the product parameter seeds and the merging process. The transformed hierarchical product parameter may then be updated in the hierarchical product parameters map within the hierarchy of operational factors associated with the offering.

In an example, the system 200 may update the existing hierarchical product parameters map upon detecting changes or relevant information on an existing hierarchical product parameter. In another example, the system may establish relationships between the existing hierarchical product parameter and the generated or modified hierarchical product parameter. Thus, the system may allow for a dynamic and responsive hierarchy that evolves based on real-time data from the various connected data sources within the organization. The automated nature of the process may reduce manual effort, increase consistency, and enable faster updates to the organizational structure represented in the hierarchy of operational factors.

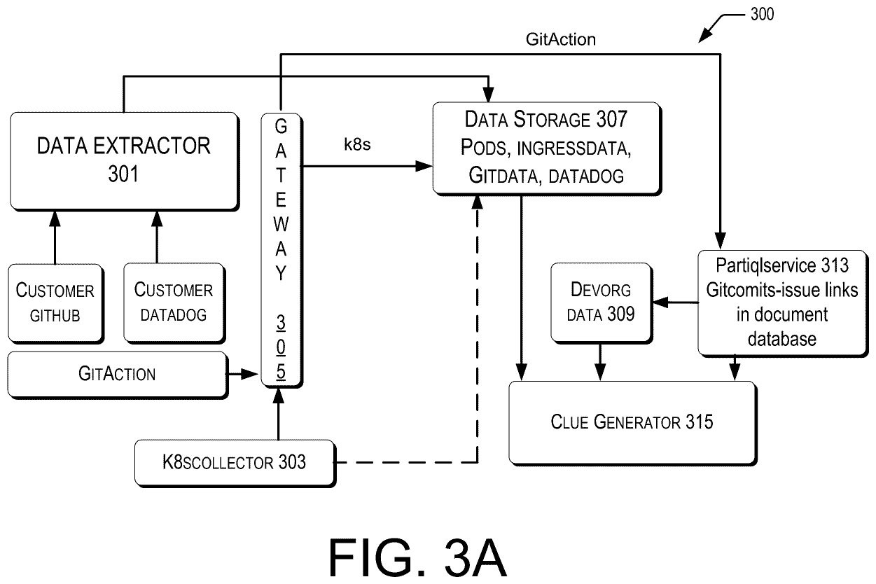

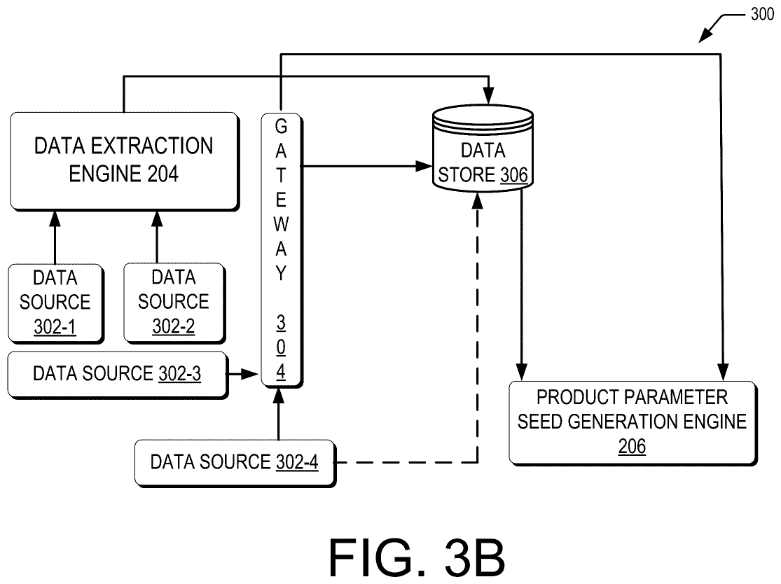

FIG. 3A illustrates a block diagram of a clue-generating module of the part discovery module suitable for implementing an embodiment of the present subject matter. FIG. 3B illustrates a conceptual schematic for generation of product parameter seeds, according to an example implementation of the present subject matter. For the sake of brevity, FIG. 3A has been explained in conjunction with FIG. 3B.

The clue-generating module (FIG. 3A) of the part discovery module, in accordance with one of the exemplary embodiments of the present specification, comprises a data extraction module 301, which collects data and extracts data from distinct sources. For each data source type, an independent extractor is suitable for extracting data extracts (event data, structure data, unstructured data). For example, cloud-scale applications data, data events collected from monitoring of servers, databases, tools, and services through a SaaS-based data analytics platform (like datadog), natural language text from web pages such as billing pages and product description pages, and event data like tracking source-code changes (git data) are collected and converted into an open standard format or a data interchange format (like JSON). Such converted data files are transferred into a data storage 308. Other data from sources like Kubernetes (software deployment, scaling, and management), wherein a collector 303 (kubernetes collector) is installed on the customer's cluster (where their other kubernetes services are running) to gather data on the kubernetes services deployed in the customer environment and the extracted event data is converted into open standard format file (like JSON) and uploads it to data storage through an API call that goes through the gateway 305. Real-time event data from Git Actions (e.g., pull request opened) and pull request's associated issues is obtained through GitHub webhook, through gateway 305 into the Partiql service 313. It is processed in the Partiql service and stored in Mongo as Git Events 313. The event data from the existing parts (DevOrg data, (records from Pin Table, which would later be generated as clues, partitioned with the rest, and a merger module of the clue processing system might treat the clues originating in pinning data with precedence over other clues) is also extracted from the Partiql service. The data collected from sources and stored (such as Git data, datadog service data, pods, ingress data, existing Part table, and Git Events) is transferred to a clue generator 315, which generates a clue that is meaningful data extract (isomorphic variation of a part) to automate the generation of a part.

The data extraction 301 is achieved by collecting data from distinct sources (like customer Git and customer Datadog data records). The data from a source like Git is extracted based on an established customer connection to a Git provider (Github, Gitlab, etc.); during scanning, repositories are accessed, and the data extractor extracts the API Endpoints described in the specification files, as well as their request and response structure, their hierarchical descriptions from the specification file and the actions (the HTTP actions) permitted by the endpoint. These endpoints are rev-centric part clues. Further, the data extractor extracts Package/library dependencies (e.g., go.mod in the case of golang) standard files describing the build configurations of a package or repository. Through the build specification files, the part discovery module constructs dev-centric part clues that help to construct the customer's dev parts and their inter-dependencies. The data extracted from Git using an extractor suitable for the Git repository is converted into a standard format record and is transferred and stored in data storage 307 in the form of Git data, wherein the generated standard format file (like JSON) is stored in the data storage 307.

In accordance with one of the exemplary embodiments, the Git-Actions are extracted and converted into Dev clues. The customers can connect their GitHub profiles to their organizational account. They can set up a GitHub web-hook to push real-time Git actions, such as branches created or newly pushed commits to the respective organization. They can associate PRs with the organization's work items (primarily issues). Each Dev part is associated with a repository, and the Git-actions are converted into Dev clues (wherein Dev clue has at least one data field that can determine the grouping and merging of clues). Suppose no dev part is associated with the repository corresponding to Git-actions. In that case, such an event is added to a database collection that can be further used as a Dev Clue by the part discovery module. A pull request (PR) is associated with an issue in the organization's workplace associated with a Rev part (a feature). Based on the PR's repository, the part discovery module connects its dev and rev parts. Real-time data from git actions (e.g., pull request opened) and pull request's associated issues is obtained through GitHub webhook, through the gateway into the Partiql service. It is processed in the Partiql service and stored in Mongo as Git Events 313.

In accordance with one of the exemplary embodiments of the present specification, the data extracts extracted from multiple sources are stored in the data storage of the part discovery module, wherein data extracts generated from each data source are stored independently (such as pods, services, and ingress data extracted kubernetes, git data and datadog data.)

In accordance with one of the exemplary embodiments, dev clues are transformed into Dev Parts, and rev clues are transformed into Rev Parts. Dev clues are grouped based on derived similarity to form a Dev Part. For Rev Parts, Rev Clues are grouped based on their API endpoint paths, and then transform each merged clue into a Part. Non-grouped API paths are grouped as a miscellaneous Rev Part.

FIG. 3B illustrates a conceptual schematic 300 for generation of clue, i.e., product parameter seed, in accordance with an example implementation of the present subject matter. In the following description of FIG. 3B, reference will be made to the elements and features described in FIGS. 1, 2, and 3A and the detailed description provided above. For the sake of brevity, the full descriptions of these elements and features will not be reproduced here, but are incorporated by reference and should be understood as applicable to the discussion of FIG. 3B. FIG. 3B has been explained to provide an exemplary implementation of the system 200 described in FIG. 2.

The data extraction engine 204 may acquire heterogenous data of varying data types from a variety of data sources, such as data sources, 302-1, 302-2, 302-3, and 302-4. In an example, but not limited thereto, the data source 302-1 may be a version control system, for example, GitHub® in the user ecosystem 118. Further, a data source 302-2 may be a monitoring and analytics system, for example, Datadog® at the user ecosystem 118. Furthermore, the data source 302-3 may be a record of a Git-action. Additionally, the data source 302-4 may be a k8s collector (cron job, Kubernetes cluster).

For each data source type, the data extraction engine 204 may employ an extraction tool, for example, the connectors, the rovers, and the APIs. The extraction tools may store all the extracted data. The extracted data may be accessed by the product parameter seed generation engine 206 that may process the extracted data and convert the extracted data into a product parameter seed. The product parameter seed may be an isomorphic form of a hierarchical product parameter, which may or may not comprise all data fields or attributes defined in the hierarchical product parameter. The product parameter seed, in an example, may be understood as a structured data object with defined data fields.

The heterogenous data may include event data, structured data, non-structured data, and the like. For example, for cloud-scale applications, event data may be acquired from monitoring of servers, databases, tools, and services through a SaaS-based data analytics platform (for instance, Datadog®). Further, event data such as data change monitoring (for instance, from GitHub®) may also be acquired by the data extraction engine 204. The extracted data may be, in an example, normalized and converted into an open standard format or a data interchange format (like JSON) for ease of reference by different engine(s) in the system 200.

In another example, the data source 302-3, for example, the container orchestration system, may include a data extraction tools installed on an entity cluster in the discrete ecosystem. The container orchestration system may be explained herein with respect to the Kubernetes® platform, but is not limited thereto. The entity cluster may refer to a cluster of entities where different instances of one or more Kubernetes® services may be running. The entity cluster may include a Kubernetes® collector installed on the entity cluster to gather data on the Kubernetes® services deployed in, for example, the user ecosystem 118. The data collected by the Kubernetes® collector may be acquired by the data extraction engine 204 using, for example, an API call. The data extraction engine 204 may convert the acquired data into an open standard format file (for example, JSON) and upload to a data store 306 through an API call which goes through a gateway 304.

In yet another example, data extraction through the data source 302-1, for example, the version control system, is explained herewith with respect to a GitHub® system as an example, but the same is not limited thereto. The data extraction engine 204 may obtain real-time event data from Git Actions (e.g., pull request opened) and pull request's associated issues through GitHub webhook, via the gateway 304. The data extraction engine 204 may process the extracted data and store the processed in the data store 306 as Git Events. In an example, the data extraction engine 204 may use Partiql® service for processing the extracted data. The extracted data (such as Git data, datadog service data, pods, ingress data, Git Events, and the like) is transferred to the product parameter seed generation engine 206 which may generate a product parameter seed that is meaningful data extract (isomorphic variation of a hierarchical product parameter) to automate the generation of the hierarchical product parameters, such as capability, feature, microservice, and sub-module, related to the offering. The extracted data may either be directly transferred to the product parameter seed generation engine 206 or via various other services.

The data extraction engine 204 may extract data from distinct sources like user-end Git, for example, data source 302-1 and user-end Datadog data records, for example, data source 302-2. The data from a version control system like Git may be acquired based on an established connection of a user entity or a CRM entity to a Git provider (GitHub®, Gitlab, etc.). During scanning, the data extraction engine 204 may access repositories and may obtain heterogenous data, for example, API Endpoints described in the API spec file (e.g., swagger file), as well as their request and response structure, relational context information from the specification file, and the actions (the HTTP actions) permitted by the endpoint.

In the example explained in FIG. 3, the endpoints are explained as being user ecosystem 118 or CRM ecosystem 130 centric product parameter seeds. The data extraction engine 204 may obtain Package/library dependencies (e.g., go.mod in the case of golang) and standard files describing the build configurations of a package or repository. Through the build specification, the system 200 may construct product parameter seeds pertaining to developer and/or operations ecosystems for linked hierarchical product parameter. The description of FIG. 3 has been explained in relation to generating a hierarchical product parameter pertaining to the development ecosystem 112 based on sets of telemetry information obtained from the user ecosystem 118. The references to the development ecosystem 112 and the user ecosystem 118 are only for explanatory purposes and shall not be construed as a limitation.

The data extraction engine 204 may use an extraction tool suitable for a Git repository to obtain one or more sets of telemetry information from the Git repository linked to a user entity. The acquired data may be converted into a standard format record and is transferred and stored in a data store 306 in the form of Git data. The generated standard format file (like JSON) is stored in the data store 306.

The data extraction engine 204 may use a data extraction tool suitable to obtain sets of telemetry data from sources like Datadog®, for example, data source 302-2. The APIs exposed by datadog may be used to pull a conceived service map with dependencies. The extracted data comprising sets of telemetry information from the user entity datadog service may be converted into standard format record and stored in the data store 306 in the form of datadog data, where the generated standard format file (like JSON file) is transferred and stored in the data store 306.

In one of the exemplary embodiments, the data extraction engine 204 may acquire sets of telemetry information from existing hierarchical product parameters, for example, in the development ecosystem 112. Every existing set of telemetry information is transformed into a product parameter seed for the development ecosystem 112, and service dependencies are transformed into links between different hierarchical product parameters. Existing sets of telemetry information including, among others, pinning information describing user modifications to the existing hierarchical product parameters are fetched by querying the development ecosystem 112 and the acquired sets of telemetry information is transformed into product parameter seeds.

In addition to the above, the data extraction engine 204 may extract data from the data source 302-4 from a containerization system like Kubernetes®. In the example, the data extraction engine 204 may use a Kubernetes collector, which periodically gathers data at configured frequency using core Kubernetes APIs to obtain microservice data. The extracted data may be transformed to a product parameter seed executable to generate a hierarchical product parameter to be integrated with the development ecosystem 112.

The data extraction engine 204 may in an example transmit the extracted data over cloud over HTTPS. Once the cloud receives the extracted data, the extracted data may get securely stored in the data store 306. The extracted data may include services, pods, and ingress information. The data store 306 may also be stored locally in the system 200. The extracted data, in turn, may be used by the system 200 to first create product parameter seeds that may be executable to ultimately deduce appropriate hierarchical product parameters and links between the hierarchical product parameters. The data acquired from the Kubernetes source 302-4 is converted into a standard format record and stored in data store 306 in the form of pods, services, and ingress data, wherein the generated standard format file is transferred through an API call and stored in the data store 306.

In accordance with one of the exemplary embodiments, the data extraction engine 204 may obtain Git-action from the data source 302-3. The Git-Actions may be processed to generate product parameter seeds. The product parameter seeds may, in the present example for explanatory purposes, be related to hierarchical product parameters operating in the development ecosystem 112, but not limited thereto. The entities operating in the connected environment 100 may connect their individual GitHub profiles to the system 200. Such entities may set up a GitHub web-hook to push real-time Git actions, such as branches created or newly pushed commits to the system 200. The data extraction engine 204 may acquire the data and may associate Pull Requests with actionable items (for example, primarily issues with respect to the development ecosystem 112) in the sets of telemetry information. Each developer entity 114 may be related to a repository, and the Git-actions may be converted into product parameter seeds associated with the development ecosystem based on the pull requests (PRs) within the repository. In case no developer end hierarchical product parameter is associated with the repository corresponding to the git-Action/PR, an event is added to a database collection that can be further used as a product parameter seed by the system 200. A PR may be associated with an issue in the connected system related to, for example, a feature in the user ecosystem 118. Based on the PR's repository, the system 200 may connect the developer entities 114 and the user entities 120. Real-time data from git actions (e.g., pull request opened) and pull request's associated issues is obtained through GitHub webhook, through the gateway. The acquired data may be processed and stored as Git Events in the data store 306 (for example, events collection). The acquired data may then be used by the product parameter seed generation engine 206 to generate product parameter seeds. In an example, the raw sets of telemetry information may be obtained directly by the product parameter seed generation engine 206 to generate product parameter seeds.

In accordance with one of the exemplary embodiments of the present specification, the product parameter seeds may be extracted from a plurality of connected sources and stored in the data storage of the system 200. Further, the sets of telemetry information obtained from each data source are stored independently (such as pods and ingress data extracted from Kubernetes®, git data, and datadog data).

In accordance with one of the exemplary embodiments, product parameter seeds may be transformed into hierarchical product parameters associated with one or more of the discrete ecosystems operating in the connected environment 100. For a hierarchical product parameter at the development ecosystem, distinct source data is differentiated, and code work is developed to deduce product parameter seeds (such as commits or PRs linked to an enhancement). A group of product parameter seeds (grouped by identifying similarities) may be transformed into a hierarchical product parameter. For example, the product parameter seed may include a JSON file usable to form a hierarchical product parameter in the development ecosystem 112.

Similarly, for the user ecosystem 118, product parameter seeds may be grouped based on their API endpoint paths and then each product parameter seed may be transformed into a hierarchical product parameter. Non-grouped API paths may be grouped as a miscellaneous user-end hierarchical product parameter. For example, the product parameter seed may include a JSON file usable to form a hierarchical product parameter in the user ecosystem 118:

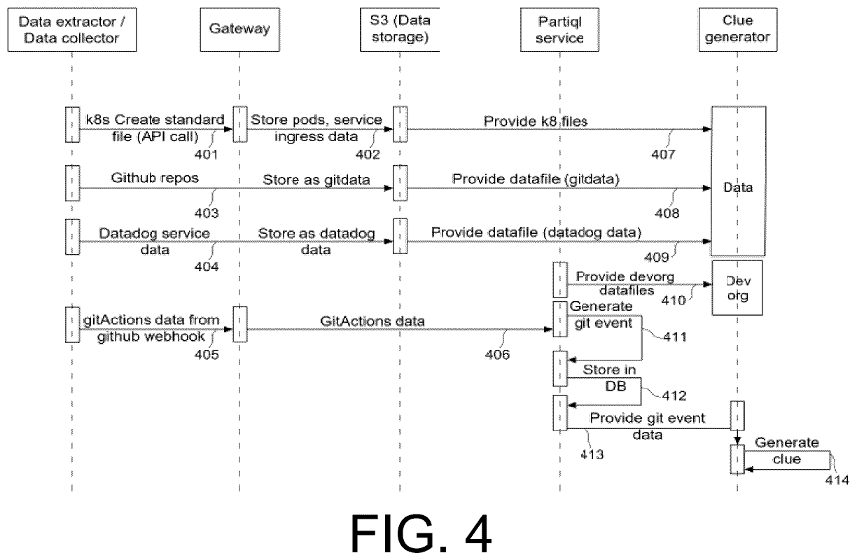

FIG. 4 illustrates a process of extraction and conversion of product parameter seeds, according to an example implementation of the present subject matter. The data extraction and product parameter seed generation process may involve multiple components and data flows. In an example, a data extractor, such as a Kubernetes collector, may gather data on Kubernetes® services, deployed in the customer environment. The data extractor may correspond to the data extraction engine 204. The Kubernetes collector constructs a standard format representation 401 of the gathered data and uploads the gathered data 402 to a data storage. For example, the gathered data 402 may be uploaded through an API call routed via a gateway service. Further, the data may be transferred to a clue generator 407. The clue generator 407 may correspond to the product parameter seed generation engine 206.

In an example, the system may include a data collection service that connects to various customer-configured data sources, such as GitHub repositories 403 and monitoring services like Datadog® 404. This data collection service may gather data from the sources and construct standardized format files, using formats such as JSON or YAML. The standardized format files may then be uploaded to the data storage. In an example, within the data storage, information from different sources may be stored separately. For instance, Git data 406 and customer Datadog data 404 may be maintained in distinct storage locations or partitions. The segregated data may then be transferred to the clue generator (408, 409) for further processing.

The system may also extract data from a DevOrg component 410, which may comprise real-time events (such as updates, modifications, deletions, or additions) executed on existing hierarchical product parameters in the hierarchical product parameters map. The data for real-time events may be extracted from a Partiql® service and transferred to the clue generator 413. In an example, real-time data from Git actions 406, such as opened pull requests and their associated issues, may be obtained through a GitHub webhook 405. The real-time data may be routed through a gateway into the Partiql® service 411, where it may be processed and subsequently stored in a database (e.g., MongoDB) as Git Events 412.

The clue generator may transform all the extracted data into a common part product parameter seed format. Git event data may be transferred to the clue generator 413, which may then analyze data from all sources to generate product parameter seeds 414. In an example, the clue generator may be invoked via an API at regular intervals. The primary functions of the clue generator may include generating product parameter seeds, creating Rev hierarchical product parameters and Dev hierarchical product parameters, establishing interconnections between the Rev and Dev hierarchical product parameters, and updating the hierarchical product parameters map in the hierarchy of operational factors associated with the product or service. In some scenarios, the system may employ data streaming technologies to handle real-time data flows more efficiently. The system may also use machine learning algorithms to improve its data transformation and product parameter seed generation processes over time, adapting to patterns in the incoming data.

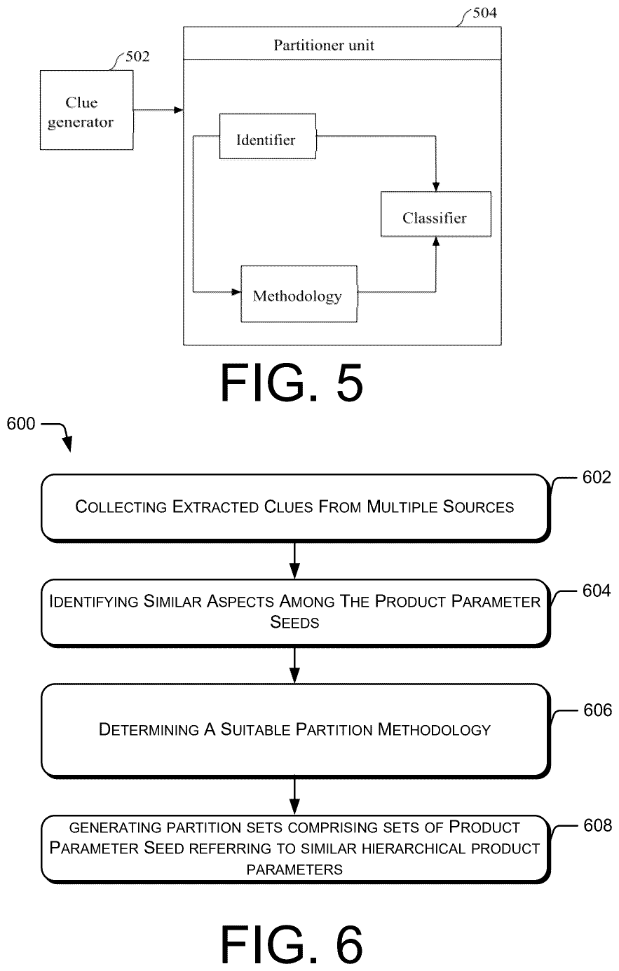

FIG. 5 illustrates a partitioner unit 504 for grouping of generated product parameter seeds, according to an example implementation of the present subject matter. The partitioner unit 504 may correspond to the partition engine 208. Each partition set may comprise a collection of product parameter seeds sharing certain characteristics. Within each product parameter seed, data fields may be optional, allowing product parameter seeds from separate resources to have the same fields populated with definite or default values. In an example, the product parameter seeds within a partition set may likely point to the same object within the system.

In an example implementation, the partitioner unit 504 comprises an identifier and a classifier. This identifier may be configured to recognize similar aspects among the product parameter seeds that may refer to the same object. For instance, the similar aspects may include attributes of data fields, the source of the product parameter seed, or the method of extraction. The partitioner unit 504 groups the product parameter seeds gathered from the product parameter seed generator. Further, the classifier may implement specific methodologies to group product parameter seeds with similar aspects into a single partition. The system may select from a variety of methodologies, which could include, but are not limited to algorithmic approaches (e.g., clustering algorithms), syntactic processing techniques, semantic grouping methods, machine learning or AI techniques, and other suitable methods compatible with the product parameter seed's data structure. The methods may be designed to analyze the data from each product parameter seed and derive conclusions, which can then be used for grouping through the application of logical reasoning.

In an example, for generating a dev partition set, the grouping process may consider similarities in namespaces (including prefixes and suffixes) of attributes, properties of data fields, and hash numbers attributed to data fields that refer to similar objects. This approach may help in identifying product parameter seeds related to similar development components or processes. In another example, for generating a rev partition set, the grouping may primarily depend on name similarities and analogous API endpoints. This approach may be particularly effective in identifying product parameter seeds related to similar features or services from a user or revenue perspective. In another example, the system may employ hybrid approaches, combining multiple methodologies to improve grouping accuracy. For instance, it might use semantic analysis in conjunction with machine learning techniques to identify non-obvious relationships between product parameter seeds.

In an example implementation, the partitioner unit 504 may implement a variety of advanced techniques to derive similarities between product parameter seeds. These techniques may include, but are not limited to, machine learning (ML) approaches to identify patterns and similarities among product parameter seeds, logical semantics analysis to map product parameter seeds to predefined concepts and relationships within the system's domain, and contextual processing methods employed on the data fields of each product parameter seed. In an example, the partitioner unit 504 may implement these techniques in combination, potentially using ensemble methods to leverage the strengths of multiple approaches. For instance, it might use ML to identify initial groupings, then refine these groups using logical semantics and contextual analysis.

FIG. 6 illustrates a method 600 for grouping the product parameter seeds into partition sets, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 600 may be performed by the system 200 in the connected environment 100.

At step 602, the method 600 may include collecting the extracted and generated product parameter seeds from the product parameter seed generator. This collection process may involve aggregating product parameter seeds from various sources and potentially preprocessing them to ensure consistency in format and structure. Following collection, at step 604, the method 600 may include identifying similar aspects among the product parameter seeds. In an example, the aspects may include attributes, data fields, or semantically or syntactically similar attributes. The identification process may employ various techniques, such as feature extraction to isolate key characteristics of each product parameter seed, similarity metrics to quantify the likeness between different product parameter seeds, pattern recognition algorithms to identify recurring structures or themes. At step 606, a suitable partition methodology to execute the grouping of similar product parameter seeds may be determined. In an example, the determination of the suitable partition methodology may be based on the source and nature of the product parameter seeds. Further, the determination may include analyzing the characteristics of the product parameter seeds and selecting the most appropriate method or combination of methods. The system may choose from a diverse range of methodologies, including but not limited to clustering algorithms, syntactic processing techniques, semantic grouping methods, machine learning techniques, natural language processing approaches for text-based product parameter seeds, and graph-based algorithms for product parameter seeds with relational data. The selected methods may be designed to analyze the data from each product parameter seed and derive conclusions that can be used for grouping through the application of logical reasoning.

At step 608, the method includes generating partition sets comprising sets of product parameter seeds that likely refer to similar hierarchical product parameters. In an example implementation, the generation process may involve applying the chosen methodology to create initial groupings, refining the groupings through iterative processes, and validating the coherence and distinctiveness of each partition set. In an example, the machine learning and Al techniques may be employed to derive similarities between product parameter seeds. Also, other methodologies like logical semantics and contextualization can be employed on the data fields of each product parameter seed.

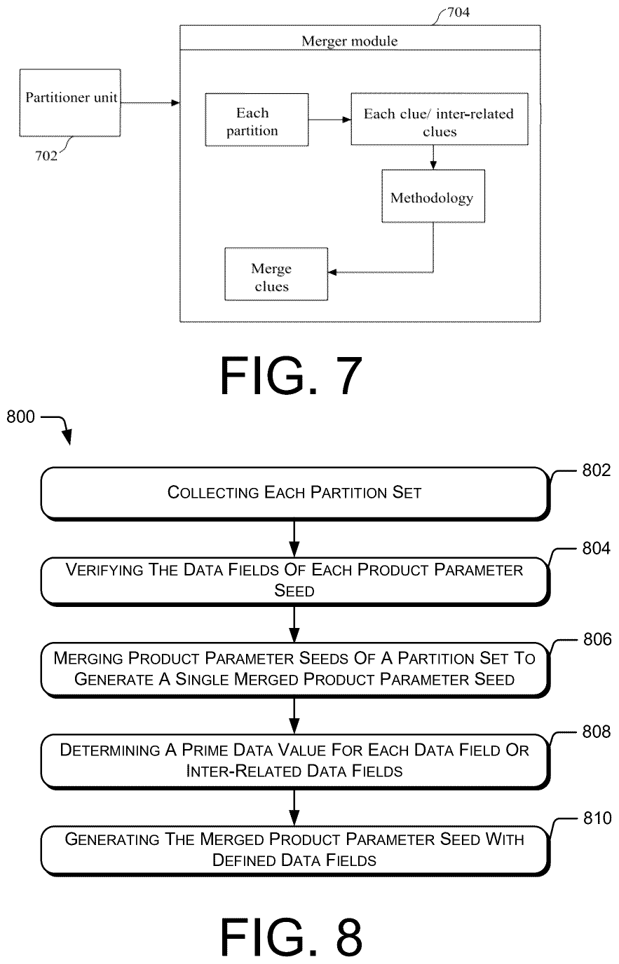

FIG. 7 illustrates a merger module 704 for merging the product parameter seeds in the partition set, according to an example implementation of the present subject matter. The product parameter seeds is referred to as clues. The merger module 704 may correspond to the product parameter seed merger engine 210. The merger module 704 may execute a merging operation on the generated partition set from a partitioner unit 702 to produce a merged product parameter seed. The partitioner unit 702 may correspond to the partitioner unit 504 and partition engine 208. In an example, the merged product parameter seed may comprise a single, comprehensive representation with a format consistent with the product parameter seeds in the original partition set. In operation, the merger module 704 may employ various techniques to determine the optimal source for each specific field or set of fields within the partition set. For example, the determination process may involve evaluating the reliability and completeness of data from different source, considering the recency of the data in each product parameter seed, and assessing the relevance of each source to the specific field in question. The merged product parameter seed resulting from this process may be structured in a format identical to the product parameter seeds contained in the partition set, thereby ensuring consistency and compatibility with the existing systems.

In an example, the merger module 704 may utilize a selected merging methodology to determine a prime value for each data field or group of related fields. This approach may help to maintain coherence among related fields and may ensure the integrity of the merged data. The selection of prime values may involve statistical analysis to identify the most representative value, conflict resolution strategies for inconsistent data, and preservation of relationships between interdependent fields. The merger module 704 may apply either similar or distinct merging methods for each data field or group of related fields. These methods may include, but are not limited to rule-based approaches, Artificial Intelligence (AI) techniques, and Machine Learning (ML) methods. The choice of method may depend on the nature of the data field, the characteristics of the partition set, and the specific requirements of the system.

To illustrate the merging process, consider a scenario where a partition contains three product parameter seeds from data sources A, B, and C. Each product parameter seed may have three data fields: field 1, field 2, and field 3, with distinct data values for each field. The merger module 704 may combine these product parameter seeds into a single merged product parameter seed encompassing all three data fields. The data value for each field in the merged product parameter seed may be determined by implementing either the same or distinct merging methodologies on the set of values present for each field across all the three product parameter seeds. The merger module 704 may employ a variety of approaches tailored to the characteristics of each field: For field 1, a rule-based merge may be implemented. The rule-based merge may follow a priority-based logic, such as if a product parameter seed from source A is available, use its value for field 1; if no product parameter seed from source A is available, but a product parameter seed from source C is present, use the value from source C; and if neither A nor C have a value, use any available product parameter seed for field 1. This approach may be particularly useful when there's a known hierarchy of specific fields.

For field 2, AI, Generative AI, or ML techniques may be implemented. The Al or ML techniques may involve training a model on historical data to predict the most accurate or relevant value; using a clustering algorithm to identify the most representative value among the three data fields, implementing a neural network to combine the values. Such an approach may be beneficial when the relationship between the values is complex, semantic in nature, or when historical data can inform the merging decision.

For field 3, a simple concatenation rule may be implemented. The simple concatenation rule may involve combining the values from all three sources in a predetermined order; using a delimiter to separate the values from different sources; and incorporating source identifiers to maintain traceability. Such method may be useful when all values provide relevant information and the combined data is more valuable and complete than any single source.

FIG. 8 illustrates a method 800 for merging each partition set, according to an example implementation of the present subject matter. The order in which the method 800 is described is not intended to be construed as a limitation, and any number of the described method blocks may be combined in any order to implement the method 800, or an alternative method. Furthermore, the method 800 may be implemented by processor(s) or computing device(s) through any suitable hardware, non-transitory machine-readable instructions, or a combination thereof.

It may be understood that steps of the method 800 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 800 may be performed by the system 200 in the connected environment 100.

At step 802, the method 800 may include collecting each partition set. In an example, the collection step may include retrieving all product parameter seeds assigned to a specific partition set, organizing the product parameter seeds in a manner conducive to efficient processing, and verifying the integrity and completeness of the partition set. At step 804, the method 800 may include verifying all the data fields of each product parameter seed. For example, the verification step may include checking for missing or null values, validating data types and formats, identifying any anomalies or outliers in the data, and assessing the consistency of field names and structures across product parameter seeds. At step 806, the method 800 may include merging all product parameter seeds of a partition set to generate a single merged product parameter seed. The single merged product parameter seed may maintain a format similar to the original product parameter seeds in the partition set, thereby ensuring compatibility and consistency.

In an example, at step 808, a prime data value may be determined for each data field or group of inter-related data fields in the merged product parameter seed. The determination may be accomplished by implementing either the same or distinct merging methodologies on all data values accumulated for each data field from all the product parameter seeds of the partition set. In an example implementation, the methodologies may include statistical approaches (e.g., mean, median, mode), machine learning techniques (e.g., clustering, classification), rule-based systems, confidence-weighted averaging, and semantic analysis for text-based fields such as GenAI, GPT, or LLMs. Further, the methodology may be chosen depending on one or more factors such as the nature of the data (numeric, categorical, text, etc.), distribution of values across product parameter seeds, reliability of different sources in terms of specific fields, and specific requirements of the field or group of fields. At step 810, the method 800 may include generating the merged product parameter seed with defined data fields.

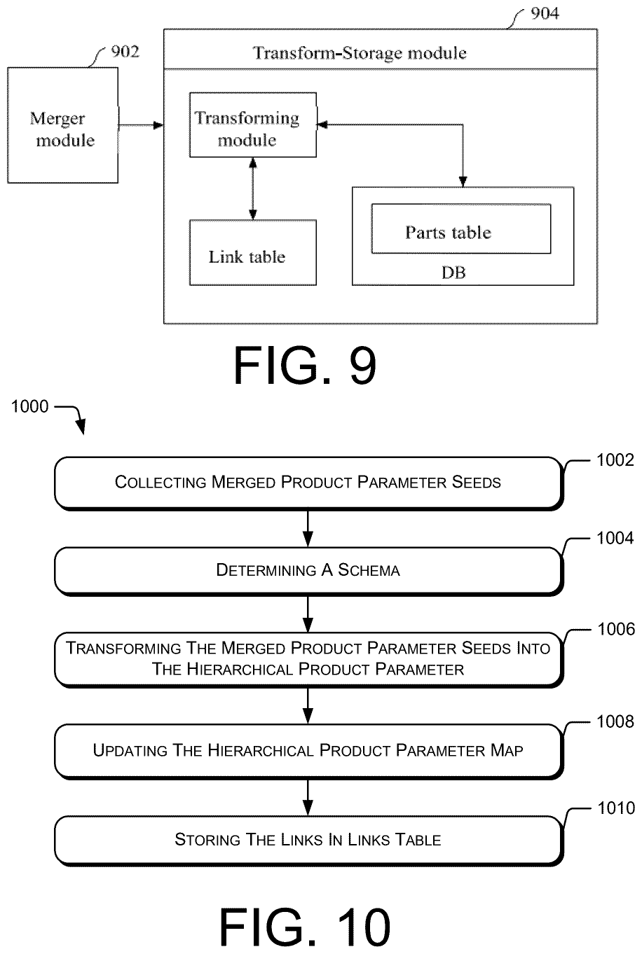

FIG. 9 illustrates a transform-storage module 904 for transforming the merged product parameter seed into a hierarchical product parameter in a hierarchy of operational factors for an offering operating in a unified platform, according to an example implementation of the present subject matter. The transform-storage module 904 may correspond to the hierarchical parameter generation engine 212. The merger module 902 may correspond to the merger module 704 and product parameter seed merger engine 210. The transform-storage module 904 may transform the merged product parameter seed, collected from the merger module 902, into the hierarchical product parameter.

The transform-storage module 904 may include a transforming module designed to convert the merged product parameter seed into hierarchical product parameter. In an example, the hierarchical product parameter may represent various elements within the system, such as capabilities, features, microservices, sub-modules. Once the hierarchical product parameter is constructed by the transforming module, it may be stored in a storage module. In an example, an appropriate storage location may be selected based on the hierarchical product parameter type and system architecture. The transform-storage module 904 may then update the hierarchical product parameters map, referred to as parts table in FIG. 9, with the newly created or modified part.

In an example, the update process may include checking for existing entries to determine if the generated parameter is a new hierarchical product parameter or an update to an existing one. For instance, the checking may be done by analyzing the product parameter seeds. In another example, versioning or timestamping may be applied to track changes in the hierarchical product parameter over time. Further, in addition to transforming the merged product parameter seed into hierarchical product parameter, the transform-storage module 904 may also process relationships between parts. Links between merged product parameter seeds may be transformed into Link schemas, representing connections or associations between the created parts. These Link schemas may be stored in a dedicated Links table. For instance, the link transformation process may include identifying relevant relationships from the merged product parameter seeds, mapping the relevant relationships to appropriate link types in the system, generating unique identifiers for each link, and establishing bidirectional references, if required. In an example, to ensure compatibility with existing systems, the transformed hierarchical product parameters may be converted into a format that aligns with the schema defined in the available databases.

FIG. 10 illustrates a method 1000 for transforming the merged product parameter seed into the hierarchical product parameter in the hierarchy of operational factors associated with the product or service, according to an example implementation of the present subject matter. The order in which the method 1000 is described is not intended to be construed as a limitation, and any number of the described method blocks may be combined in any order to implement the method 1000, or an alternative method. Furthermore, the method 1000 may be implemented by processor(s) or computing device(s) through any suitable hardware, non-transitory machine-readable instructions, or a combination thereof.

It may be understood that steps of the method 1000 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 1000 may be performed by the system 200 in the connected environment 100.

At step 1002, the method 1000 may include collecting a merged product parameter seed. The merged product parameter seed may be retrieved from the merger module. At step 1004, the method 1000 includes determining a schema to be compatible with the available storage medium. In an example, the compatible schema may be determined by analyzing the structure of the merged product parameter seed, identifying the appropriate target schema in the storage medium, and mapping fields from the merged product parameter seed to corresponding attributes in the target schema. At step 1006, the method 1000 includes transforming the merged product parameter seed into the hierarchical product parameter. After the hierarchical product parameter is created, at step 1008, the method 1000 includes updating the hierarchical product parameter map in the hierarchy of operational factors associated with the product or service. In an example, in parallel with hierarchical product parameter creation, the method includes transforming links between the merged product parameter seeds into Links schemas between the created parameters. At step 1010, the transformed links may be stored in the Links table.

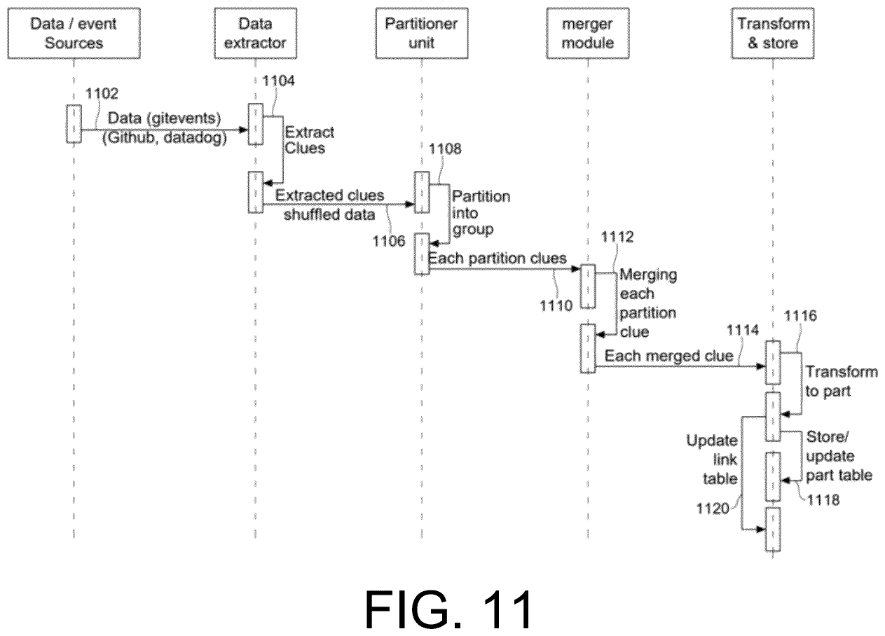

FIG. 11 illustrates a method for processing a product parameter seed into a hierarchical product parameter in a hierarchy of operational factors associated with the product or service, according to an example implementation of the present subject matter. The processing of product parameter seeds into hierarchical product parameter comprises generating product parameter seeds by collecting and extracting data 1102 from distinct sources and extracting product parameter seeds 1104 from the extracted data, wherein data extracts are converted into a standard part product parameter seed format. The generated product parameter seeds may be grouped by transferring the generated product parameter seeds to a partitioner unit 1106 and grouping a set of product parameter seeds 1108 which likely refer to the same object into a partition set. Each partition set may then be merged by transferring each partition set (grouped product parameter seeds) to a merger module 1110 to merge the set of product parameter seeds into a merged product parameter seed 1112. The merged product parameter seeds are then transferred to a transform-storage module 1114 to execute transformation of the merged product parameter seed into the hierarchical product parameter 1116. The generated hierarchical product parameter may then be stored in the hierarchy. Further, the hierarchical product parameter may be updated in the hierarchical product parameter map 1118. In addition, links between the hierarchical product parameter map may be updated in the links table 1120.

The present subject matter thus provides a flexible and efficient approach to manage data from various sources, process the data, and update the hierarchy of operational factors while maintaining data integrity and relationships. The system handles data from diverse data sources with different formats by converting all inputs into a common product parameter seed format for consistent processing. By extracting data from multiple sources and converting it into product parameter seeds, the system automates a significant portion of the data integration process, thereby reducing manual effort and potential errors. Further, the modular design of the system allows for easy addition of new data sources and product parameter seeds, making it adaptable to growing organizational needs.

Furthermore, by organizing information into a structured hierarchy of operational factors, the system makes it easier for organizations to analyze, query, and derive insights from their data. The system can process new data and update existing parts in the hierarchy, ensuring that the organization's data remains current and accurate. The common product parameter seed format and standardized hierarchical product parameter structure also facilitates better integration with other systems and tools within the organization. These technical advantages collectively contribute to a more efficient, reliable, and manageable system for automatically generating new hierarchical product parameters of a product or service, addressing key challenges faced in conventional systems.

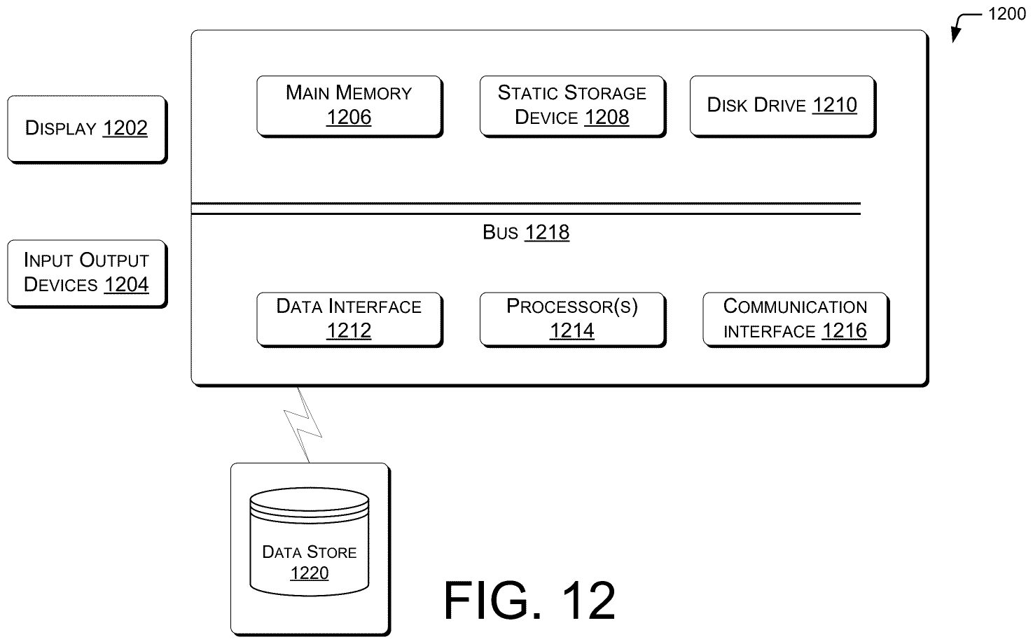

FIG. 12 is a block diagram of an illustrative computing system 1200 suitable for implementing an embodiment of the present invention. Computing system 1200 includes a bus 1218 or other communication mechanism for communicating information, which interconnects subsystems and devices, such as processor 1214, main memory 1206 (e.g., RAM), static storage device 1208 (e.g., ROM), disk drive 1210 (e.g., magnetic or optical), communication interface 1216 (e.g., modem or Ethernet card), display 1202 (e.g., CRT or LCD), input device 1204 (e.g., keyboard, and cursor control).

According to one embodiment of the present subject matter, the computing system 1200 performs specific operations by the processor 1214 executing one or more sequences of one or more instructions contained in main memory 1206. Such instructions may be read into main memory 1206 from another computer readable/usable medium, such as static storage device 1208 or disk drive 1210. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor 1214 for execution. Such a medium may take many forms, including but not limited to, non-volatile media and volatile media. Non-volatile media includes, for example, optical or magnetic disks, such as disk drive 1210. Volatile media includes dynamic memory, such as main memory 1206. A data store 1220 may be accessed in a computer readable medium using a data interface 1212.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 1200. According to other embodiments of the present subject matter, two or more computing systems 1200 coupled by communication link (e.g., LAN, PTSN, or wireless network) may perform the sequence of instructions required to practice the invention in coordination with one another.

Computing system 1200 may transmit and receive messages, data, and instructions, including program, i.e., application code, through communication link and communication interface 1216. Received program code may be executed by processor 1214 as it is received, and/or stored in disk drive 1210, or other non-volatile storage for later execution.

In the foregoing specification, the present subject matter has been described with reference to specific embodiments thereof. It will, however, be evident that various modifications and changes may be made thereto without departing from the broader spirit and scope of the present subject matter. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A system to transform product parameter seeds into a hierarchical product parameter in the hierarchy of operational factors for an offering operating in a unified platform, the system comprising:
a processor to:
extract data from a plurality of connected data sources, each connected data source from amongst the plurality of connected data sources being operated in connection with the unified platform;
generate a plurality of product parameter seeds from the extracted data by converting the extracted data into a standard product parameter seed format, the standard product parameter seed format being a uniform format for one or more product parameter seeds of a product parameter seed type amongst the plurality of product parameter seeds;
group the generated plurality of product parameter seeds into partition sets, each partition set comprising product parameter seeds associated with a specific object of the offering in the hierarchy of operational factors;
merge the product parameter seeds in each partition set to form a merged product parameter seed, the merged product parameter seed being a single product parameter seed representing the specific object, wherein the merged product parameter seed maintains the standard product parameter seed format of the product parameter seeds in the partition set;
transform the merged product parameter seed into the hierarchical product parameter in the hierarchy of operational factors, wherein the hierarchical product parameter is an operational factor associated with the offering within the hierarchy of operational factors; and
update the hierarchical product parameter in a hierarchical product parameter map within the hierarchy of operational factors.

2. The system of claim 1, wherein the unified platform comprises at least one of a developer-end ecosystem and a user-end ecosystem.

3. The system of claim 1, wherein the hierarchy of operational factors is formed of:
a capability representing functions performed by the offering;
a feature as a sub-unit of the capability, the feature representing an item configurable to perform a capability;
a microservice as a sub-unit of the feature, the microservice representing an executable piece of a programming file for performing the capability; and
a sub-module as a sub-unit of the microservice, the sub-module representing a set of programming code integrable in the microservice, wherein the hierarchical product parameter comprises at least one of the capability, the feature, the microservice, and the sub-module.

4. The system of claim 1, wherein the offering operating in the unified platform comprises at least one of a product and a service.

5. The system of claim 1, wherein to generate the plurality of product parameter seeds, the processor is to:
extract data from the plurality of connected data sources using data extractors specific to each type of source and convert the extracted data into the standard product parameter seed format;
transfer the converted data to a data collector;
store the converted data in the data collector; and
generate the plurality of product parameter seeds from the stored data to automate construction of hierarchical product parameters in the hierarchy of operational factors for the offering.

6. The system of claim 1, the system comprising:
an identifier to identify product parameter seeds with similar attributes, similar characteristics of data fields, and similar service interfaces among the plurality of product parameter seeds; and
a classifier to group identified product parameter seeds into the partition set.

7. The system of claim 1, wherein to form the merged product parameter seed, the processor is to:
verify data fields of each product parameter seed in the partition set;
merge all product parameter seeds of the partition set to generate a single merged product parameter seed;
determine a prime data value for each data field or group of inter-related data fields in the merged product parameter seed; and
generate a merged product parameter seed with defined data fields.

8. The system of claim 1, the system comprising:
a storage module to store the hierarchical product parameter in the hierarchical product parameter map and store links between hierarchical product parameters in a link table.

9. A method for transforming product parameter seeds into a hierarchical product parameter in the hierarchy of operational factors for an offering operating in a unified platform, the method comprising:
extracting data from a plurality of connected data sources, each connected data source from amongst the plurality of connected data sources being operated in connection with the unified platform;
generating a plurality of product parameter seeds from the extracted data by converting the extracted data into a standard product parameter seed format, the standard product parameter seed format being a uniform format for one or more product parameter seeds of a product parameter seed type amongst the plurality of product parameter seeds;
grouping the generated plurality of product parameter seeds into partition sets, each partition set comprising product parameter seeds associated with a specific object of the offering in the hierarchy of operational factors;
merging the product parameter seeds in each partition set to form a merged product parameter seed, the merged product parameter seed being a single product parameter seed representing the specific object, wherein the merged product parameter seed maintains the standard product parameter seed format of the product parameter seeds in the partition set;
transforming the merged product parameter seed into the hierarchical product parameter in the hierarchy of operational factors, wherein the hierarchical product parameter is an operational factor associated with the offering within the hierarchy of operational factors; and
updating the hierarchical product parameter in a hierarchical product parameter map within the hierarchy of operational factors.

10. The method of claim 9, wherein the unified platform comprises at least one of a developer-end ecosystem and a user-end ecosystem.

11. The method of claim 9, wherein the hierarchy of operational factors is formed of:
a capability representing functions performed by the offering;
a feature as a sub-unit of the capability, the feature representing an item configurable to perform a capability;
a microservice as a sub-unit of the feature, the microservice representing an executable piece of a programming file for performing the capability; and
a sub-module as a sub-unit of the microservice, the sub-module representing a set of programming code integrable in the microservice, wherein the hierarchical product parameter comprises at least one of the capability, the feature, the microservice, and the sub-module.

12. The method of claim 9, wherein to generate the plurality of product parameter seeds, the method comprising:
extracting data from the plurality of connected data sources using data extractors specific to each type of source and convert the extracted data into the standard product parameter seed format;
transferring the converted data to a data collector;
storing the converted data in the data collector; and
generating the plurality of product parameter seeds from the stored data to automate construction of hierarchical product parameters in the hierarchy of operational factors for the offering.

13. The method of claim 9, the method comprising:
identifying product parameter seeds with similar attributes, similar characteristics of data fields, and similar service interfaces among the plurality of product parameter seeds; and
grouping identified product parameter seeds into the partition set.

14. The method of claim 9, wherein to form the merged product parameter seed, the method comprising:
verifying data fields of each product parameter seed in the partition set;
merging all product parameter seeds of the partition set to generate a single merged product parameter seed;
determining a prime data value for each data field or group of inter-related data fields in the merged product parameter seed; and
generating a merged product parameter seed with defined data fields.

15. The method of claim 9, the method comprising:
storing the hierarchical product parameter in the hierarchical product parameter map and storing links between hierarchical product parameters in a link table.

16. A non-transitory computer-readable medium comprising instructions to transform product parameter seeds into a hierarchical product parameter in the hierarchy of operational factors for an offering operating in a unified platform, the instructions being executable by a processing resource to:
extract data from a plurality of connected data sources, each connected data source from amongst the plurality of connected data sources being operated in connection with the unified platform;
generate a plurality of product parameter seeds from the extracted data by converting the extracted data into a standard product parameter seed format, the standard product parameter seed format being a uniform format for one or more product parameter seeds of a product parameter seed type amongst the plurality of product parameter seeds;
group the generated plurality of product parameter seeds into partition sets, each partition set comprising product parameter seeds associated with a specific object of the offering in the hierarchy of operational factors;
merge the product parameter seeds in each partition set to form a merged product parameter seed, the merged product parameter seed being a single product parameter seed representing the specific object, wherein the merged product parameter seed maintains the standard product parameter seed format of the product parameter seeds in the partition set;
transform the merged product parameter seed into the hierarchical product parameter in the hierarchy of operational factors, wherein the hierarchical product parameter is an operational factor associated with the offering within the hierarchy of operational factors; and
update the hierarchical product parameter in a hierarchical product parameter map within the hierarchy of operational factors.

17. The non-transitory computer-readable medium of claim 16, wherein to generate the plurality of product parameter seeds, the instructions are executed by the processing resource to:
extract data from the plurality of connected data sources using data extractors specific to each type of source and convert the extracted data into the standard product parameter seed format;
transfer the converted data to a data collector;
store the converted data in the data collector; and
generate the plurality of product parameter seeds from the stored data to automate construction of hierarchical product parameters in the hierarchy of operational factors for the offering.

18. The non-transitory computer-readable medium of claim 16, wherein to form the merged product parameter seed, the instructions are executed by the processing resource to:
verify data fields of each product parameter seed in the partition set;
merge all product parameter seeds of the partition set to generate a single merged product parameter seed;
determine a prime data value for each data field or group of inter-related data fields in the merged product parameter seed; and
generate a merged product parameter seed with defined data fields.
